(19) United States
(12) Patent Application Publication
(10) Pub. No.: US 2013/0110554 A1
(43) Pub. Date: May 2, 2013

(54) POLICY MANAGEMENT SYSTEM AND METHOD

(71) Applicant: Nagaraj V. Rao, Flower Mound, TX (US)

(72) Inventor: Nagaraj V. Rao, Flower Mound, TX (US)

(73) Assignee: WEBCETERA, L.P., Flower Mound, TX (US)

(21) Appl. No.: 13/286,011

(22) Filed: Oct. 31, 2011

(51) Int. Cl. G06Q 40/08

(52) U.S. Cl. 705/4

(57) ABSTRACT

According to one aspect of the present disclosure, a method and technique for policy management is disclosed. The method includes: receiving by a broker from a consumer a proposed modification to a policy of insurance, the policy between the consumer and an insurance provider; responsive to receiving the proposed modification, analyzing the proposed modification by a policy modification module executable by a processor unit of a data processing system against a set of policy guidelines corresponding to the insurance provider; and responsive to determining that the proposed modification complies with the set of policy guidelines, automatically amending the policy to include the proposed modification.

### BACKGROUND

Consumers looking for insurance products (e.g., automobile insurance, life insurance, home insurance, etc.) often utilize an insurance broker to obtain premium or cost information for the desired insurance product. The broker often communicates with different insurance providers on behalf of the consumer to obtain rate quote information for the consumer. The broker may also assist in facilitating the contract or policy of insurance between the consumer and the insurance provider. The broker often utilizes the Internet or other means for communicating with the different insurance providers to facilitate information gathering and policy specifics. The broker may also include an electronic interface (e.g., via the Internet) to enable a customer or consumer to access insurance-related information (e.g., rate quote information or a user account).

### BRIEF SUMMARY

According to one aspect of the present disclosure a method and technique for policy management is disclosed. The method includes: receiving by a broker from a consumer a proposed modification to a policy of insurance, the policy between the consumer and an insurance provider; responsive to receiving the proposed modification, analyzing the proposed modification by a policy modification module executable by a processor unit of a data processing system against a set of policy guidelines corresponding to the insurance provider; and responsive to determining that the proposed modification complies with the set of policy guidelines, automatically amending the policy to include the proposed modification.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a data processing system for policy management in which illustrative embodiments of the present disclosure may be implemented; and

FIG. 4 is a flow diagram illustrating an embodiment of a method for policy management.

### DETAILED DESCRIPTION

Embodiments of the present disclosure provide a method, system and computer program product for policy management. For example, in some embodiments, the method and technique includes: receiving by a broker from a consumer a proposed modification to a policy of insurance, the policy between the consumer and an insurance provider; responsive to receiving the proposed modification, analyzing the proposed modification by a policy modification module executable by a processor unit of a data processing system against a set of policy guidelines corresponding to the insurance provider; and responsive to determining that the proposed modification complies with the set of policy guidelines, automatically amending the policy to include the proposed modification. Embodiments of the present disclosure enable automatic policy management by, for example, automatically accepting a request or offer to amend a policy by automatically evaluating the request against various predefined acceptance guidelines or thresholds, such as risk attribute information and policy parameter value thresholds.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples of the computer readable storage medium may include, but not be limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

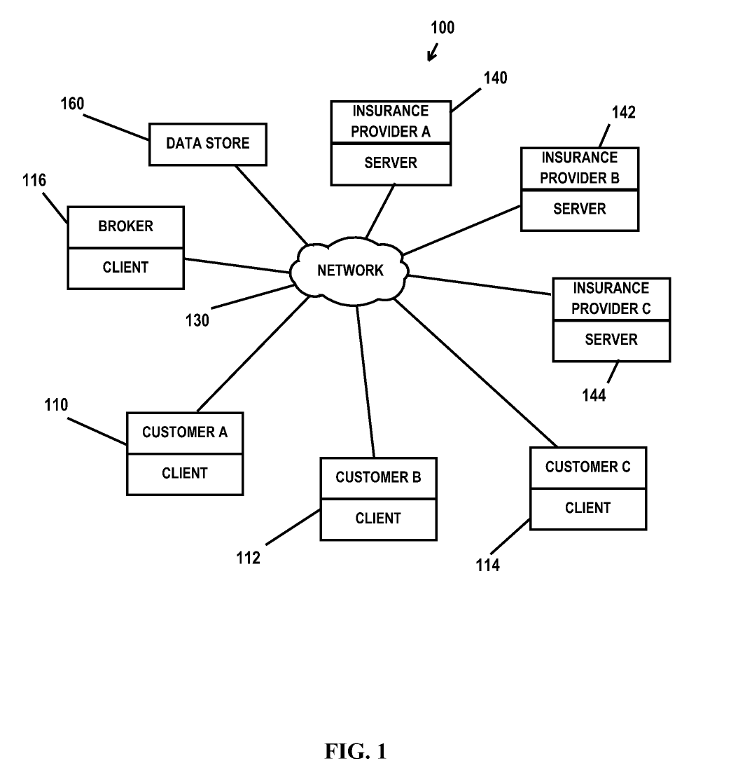

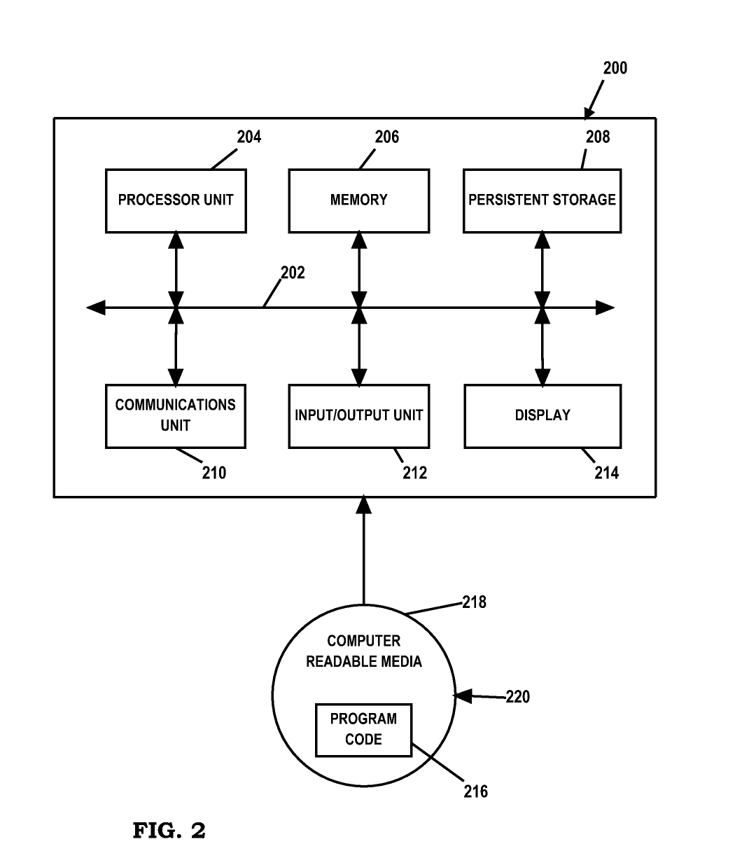

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, servers 140, 142 and 144 connect to network 130 along with data store 160. In addition, clients 110, 112, 114 and 116 connect to network 130. Clients 110, 112, 114 and 116 may be, for example, personal computers or network computers. In the depicted example, servers 140, 142 and 144 correspond to respective insurance providers A, B and C, clients 110, 112 and 114 correspond to customers or consumers of insurance products (e.g., insurance products offered and/or made available by insurance providers A, B and/or C), and client 116 is associated with an insurance broker that provides/sells insurance products to consumers (e.g., insurance products offered and/or made available by insurance providers A, B and/or C). For example, a broker as used herein may be any person that sells or otherwise provides an insurance product to a consumer (e.g., independent of whether the seller is representing the interest of the consumer (e.g., broker) or the insurance provider (e.g., agent)). Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 116 and/or server 140 in which an embodiment of a policy management system according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable. Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

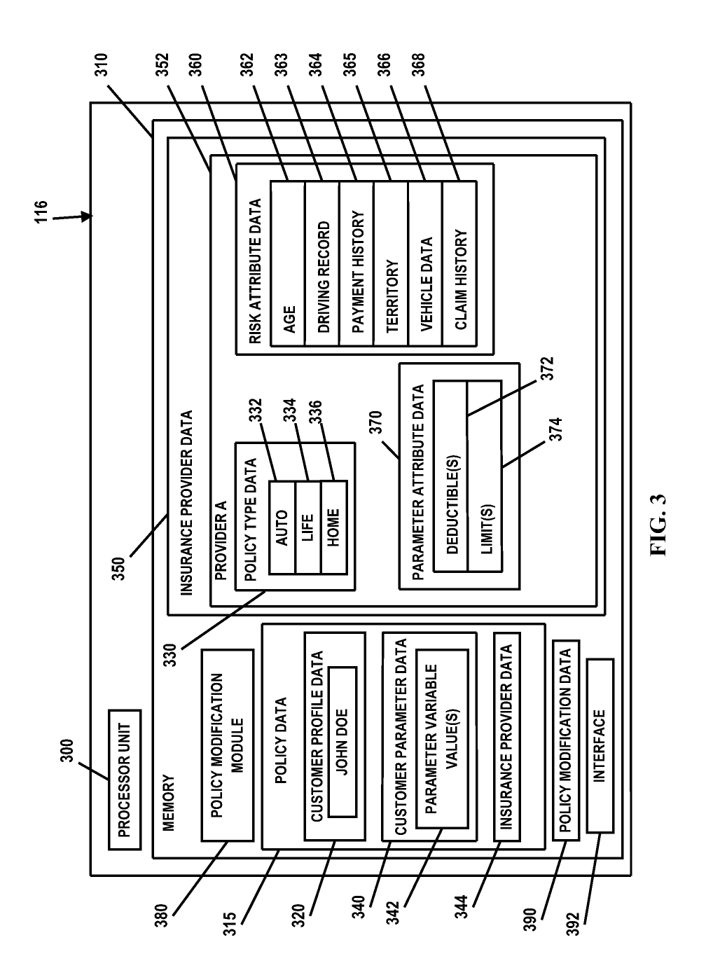

FIG. 3 is an illustrative embodiment of a system 300 for policy management. System 300 may be implemented on data processing systems or platforms such as, but not limited to, client 116 or at other data processing system locations. For example, in some embodiments, policy management system 300 is operated and/or otherwise utilized by an insurance broker. However, it should also be understood that various embodiments of policy management system 300 may be operated and/or utilized by insurance providers (e.g., on a platform such as server 140).

In FIG. 3, client 116 includes a processor unit 300 and a memory 310. In general, processor unit 300 processes and/or executes instructions (e.g., software code) and performs logic calculations while memory 310 temporarily or permanently stores information that may be retrieved therefrom. In FIG. 3, memory 310 includes policy data 315 comprising information associated with a particular policy of insurance between a particular consumer or customer and an insurance provider. For example, in FIG. 3, policy data 315 includes customer profile data 320, customer parameter data 340 and insurance provider data 344. Customer profile data 320 comprises information associated with a particular consumer or customer who has purchased an insurance product (e.g., a policy of insurance) with a particular insurance provider (e.g., via an insurance broker). For example, in FIG. 3 customer profile data 320 contains information for consumer John Doe. Customer profile data 320 may comprise various types of personal information of the customer such as, but not limited to, name, birthdate, address, telephone number, email address, etc.

Customer parameter data 340 comprises information associated with different parameters associated with a particular consumer or customer (e.g., John Doe) for a particular type of insurance product. For example, for an auto type of insurance product, customer parameter data 340 comprises different parameter variable values 342 corresponding to auto insurance such as, but not limited to, a deductible amount, a coverage amount, the type of vehicle, the address (e.g., street/city/zip code) of the user or where the vehicle will be located, the age of the insured, etc. It should be understood that for different types of insurance, different types of parameter data will be applicable. Insurance provider data 344 includes an indication of the particular insurance provider issuing the particular insurance policy.

Policy data 315 may be received from or selected by a broker or other user of client 116. For example, information associated with profile data 320 and/or parameter data 340 may be input by a broker/user and stored by client 116 as profile data 320 and parameter data 340, respectively. In some embodiments, policy data 315 may be obtained and/or received from a broker as a result of the broker securing a policy for the consumer from a particular insurance provider. Thus, it should be understood that policy data 513 may be retrieved and stored in memory 310 using a variety of methods or techniques.

In FIG. 3, memory 310 also includes insurance provider data 350. Insurance provider data 350 comprises information associated with different providers of insurance offerings (e.g., insurance providers A, B and C). For ease of illustration and description, insurance provider data 350 associated with insurance provider A 352 is illustrated in FIG. 3; however, it should be understood that memory 310 may include insurance provider data 350 for additional insurance providers. In the illustrated embodiment, insurance provider data 350 includes policy type data 330, risk attribute data 360 and parameter attribute data 370. Insurance type data 330 comprises information associated with different types of insurance or policies offered by a particular insurance provider. For example, in FIG. 3, policy type data 330 comprises information associated with an auto insurance policy type 332, a life insurance policy type 334 and a dwelling or home insurance policy type 336; however, it should be understood that different types of insurance types may be included/represented.

Risk attribute data 360 comprises information associated with various risk criteria that may be evaluated for an insured to determine whether a proposed modification to a policy of insurance meets acceptable guidelines or thresholds for a particular policy of insurance serviced by an insurance provider (e.g., provider A 352). For example, in FIG. 3, risk attribute data 360 comprises information associated with an insured's age 362, driving record 363, payment history 364, territory 365, vehicle data 366 and claim history 368. The types of risk attribute data 360 may vary based on the types of insurance policies offered or serviced by a particular insurance provider. For example, in some embodiments, for a proposed change to an auto type of policy, driving record 364 and/or age 362 criteria may be evaluated for an insured.

Parameter attribute data 370 comprises information associated with different parameter values corresponding to a particular type of insurance policy/product that may be modified based on based on risk attribute data 360. For example, in some embodiments, parameter attribute data 370 may comprise one or more thresholds or threshold values considered to be an acceptable modification to a policy attribute based on evaluated risk attribute data 360. In the embodiment illustrated in FIG. 3, parameter attribute data 370 includes a policy deductible(s) 372 and a policy limit(s) 374; however, it should be understood that other types of policy parameters or attributes may be included.

The information stored as insurance provider data 350 may be predefined and stored in memory 310 (e.g., retrieved and/or obtained from a particular insurance provider; retrieved and/or obtained from a third party, such as a third party claims adjusting service or department of motor vehicle organization; input by a broker or other user; etc.). It should be understood that insurance provider data 350 may be obtained by client 116 communicating with computers servers 140, 142 and/or 144 via network 130 to obtain insurance provider data 350. In some embodiments, polling of insurance providers may be made to obtain insurance provider data 350. Information associated with different insurance providers may also be automatically updated in response to updates automatically received from servers 140, 142 and/or 144 (e.g., without a prompt or request from client 116). In some embodiments, information may be collected from insurance providers according to a predetermined schedule to periodically update insurance provider data 350 stored in memory 310.

Memory 310 also has stored therein a policy modification module 380, policy modification data 390 and an interface 392. Policy modification data 390 comprises information associated with a proposed and/or requested change to a policy of insurance (e.g., an increase or decrease in a deductible amount, an increase or decrease in a policy limit, a modification to a vehicle type or quantity, etc.). Interface 392 functions to provide a mechanism for receiving policy modification data 390 and/or displaying a result of various operations associated with system 300. For example, in some embodiments, interface 392 may comprise an Internet- or web-based interface enabling a consumer to request various modifications to a particular policy of insurance (e.g., by presenting or displaying one or more input screens or data entry interfaces). In some embodiments, interface 392 is available through a broker (e.g., via a broker's data processing system such as system 116).

Module 380 functions to analyze policy modification data 390 and automatically determine whether modify or amend a policy of insurance based on insurance provider data 350. Module 380 and interface 392 may be implemented in any suitable manner that may be hardware-based, software-based, or some combination of both. For example, module 380 and/or interface 392 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

In some embodiments, module 380 is software (e.g., a set of instructions and/or an algorithm) that, when executed by processor unit 300, analyzes policy modification data 390 and automatically determines whether to modify or amend a policy of insurance based on insurance provider data 350. For example, module 380 may automatically access risk attribute data 360 and parameter attribute data 370 for a particular policy type 330 to evaluate policy modification data 390. If the proposed modification to a policy as indicated by policy modification data 390 meets or complies with the guidelines set forth by parameter attribute data 370, module 380 functions to automatically amend the policy and electronically notify the insurance provider (as well as the consumer and/or broker) that the policy has been amended. Thus, in operation, parameter attribute data 370 functions as a predefined set of acceptable policy modification guidelines based on risk attribute data 360 that may be triggered or automatically accepted as an amendment to a policy in response to a request to modify a policy made by a consumer or broker.

Thus, in operation, responsive to receiving and/or otherwise detecting a requested change to a policy based on policy modification data 390, module 380 accesses insurance provider data 350 corresponding to the insurance provider that issued the policy. Module 380, depending on the type 330 of policy, accesses corresponding risk attribute data 360 corresponding to the type 330 of policy. For example, for a proposed modification to an auto type policy 332 (e.g., an increase to a policy limit), module 380 may access age 362, driving record 363, payment history 364 and/or claim history 368 of the insured to evaluate the proposed modification to the auto policy. The various risk attributes may be considered in terms of frequency, quantity, or other applicable values. For example, the age of the insured may be compared to certain age ranges and, based on the particular type of policy or policy deductibles/limits, if the age of the insured is within a predefined or desired age limit or range, an adjustment to the deductibles/limits may be acceptable up to some predefined threshold. The driving record of the insured may be evaluated based on the quantity and/or severity of driving record infractions. Payment history and/or claim history, including claim amounts and frequency of claims, may be compared to predefined or desired limits or ranges. Territory and/or vehicle data may also be evaluated (e.g., based on historical costs associated with different types of vehicles, locations where the vehicle is insured, etc.). Thus, risk attribute data 360 may include attribute information of the insured as well as various limits, ranges or thresholds applicable to one or more attributes.

In response to evaluating risk attribute data 360 and determining that policy modification data 390 meets or falls within the risk attribute guidelines set forth by risk attribute data 360, module 380 accesses parameter attribute data 370 to determine whether the proposed policy modification meets or falls within one or more policy parameter value limits, ranges or thresholds. For example, in some embodiments, parameter attribute data 370 defines one or more parameter value limits, ranges or thresholds that are considered acceptable modifications based on risk attribute data 360. Thus, for example, if the insured has had no driving record infractions, a limit(s) 374 may define a significant acceptable policy limit increase is acceptable. However, if the insured has had two or more driving record infractions, a lesser policy limit increase may be allowed (or none at all). Accordingly, the amount of parameter value modification for a policy may vary depending on the particular risk attribute data 360.

In response to determining that the proposed policy modification meets or falls within the predefined guidelines as set forth by risk attribute data 360 and/or parameter attribute data 370, module 380 returns a result for the request (e.g., either accepting or denying the request for the policy change). If the request is accepted, the policy is considered to be automatically amended, and notice of the amended policy may be electronically transmitted to the insurance provider and/or another party (e.g., the broker or policyholder). In some embodiments, module 380 may indicate a different policy modification value than that requested in policy modification data 390. For example, if module 380 determines that a deductible parameter value increase is considered to be an acceptable modification to the policy but the acceptable increase is less than that requested, module 380 may indicate this lesser value to the requestor for acceptance or rejection.

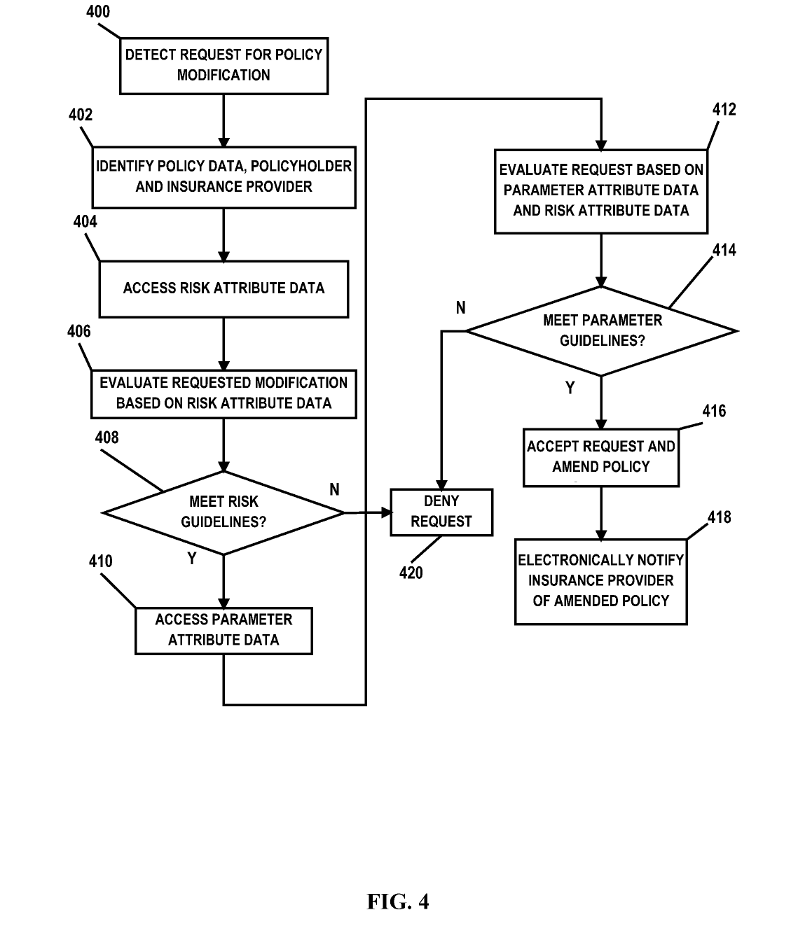

FIG. 4 is a flow diagram illustrating an embodiment of a method for policy management. The method begins at block 400, where module 380 detects a request for a policy modification in response to receiving and/or otherwise identifying policy modification data 390. At block 402, module 380 identifies policy data 315 for the request, such as an identity of the insured or policyholder and the insurance provider that issued the policy. At block 404, module 380 accesses risk attribute data 360. At block 406, module 380 evaluates and/or otherwise analyzes risk attribute data 360 in view of the requested modification to the policy.

At decisional block 408, module 380 determines whether an evaluation of risk attribute data 360 indicates that the requested policy change meets or falls within predefined risk guidelines. If not, the method proceeds to block 420, where an indication of a denial of the request is provided (e.g., via a display or electronic notice). If the request does meet or fall within risk guidelines, the method proceeds to block 410, where module 380 accesses parameter attribute data 370. At block 412, module 380 evaluates and/or otherwise analyzes parameter attribute data 370 based on risk attribute data 360 for the requested change.

At decisional block 414, module 380 determines whether an evaluation of parameter attribute data 370 indicates that the requested policy change meets or falls within predefined parameter value guidelines or thresholds based on risk attribute data 360. If not, the method proceeds to block 420, where an indication of a denial of the request is provided. If the request does meet or fall within the parameter value guidelines, the method proceeds to block 416, where module 380 accepts the request and automatically amends the policy, including automatically updating policy data 315 with the accepted modification. At block 418, module 380 electronically notifies the insurance provider of the amended policy, including the changes to the various policy parameter values.

Thus, embodiments of the present disclosure enable automatic policy management by, for example, automatically accepting a request or offer to amend a policy by automatically evaluating the request against various predefined acceptance guidelines or thresholds. Additionally, embodiments of the present disclosure enable policy modifications to be automatically instituted without the delay normally associated with manual intervention (e.g., manual review and acceptance or rejection of the requested change).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for policy management, comprising:
receiving by a broker from a consumer a proposed modification to a policy of insurance, the policy between the consumer and an insurance provider;
responsive to receiving the proposed modification, analyzing the proposed modification by a policy modification module executable by a processor unit of a data processing system against a set of policy guidelines corresponding to the insurance provider; and
responsive to determining that the proposed modification complies with the set of policy guidelines, automatically amending the policy to include the proposed modification.

2. The method of claim 1, further comprising, responsive to amending the policy, automatically transmitting an electronic notification to the insurance provider of the amended policy.

3. The method of claim 1, wherein analyzing comprises comparing the proposed modification to parameter attribute data for the policy.

4. The method of claim 1, wherein analyzing comprises:
determining a type of the policy corresponding to the proposed modification; and
analyzing risk attribute data corresponding to the type of the policy and the consumer.

5. The method of claim 1, wherein analyzing comprises:
determining whether the proposed modification corresponds to a parameter variable; and
responsive to determining that the proposed modification corresponds to a parameter variable, comparing the proposed parameter variable to parameter attribute data for the policy.

6. The method of claim 1, further comprising electronically communicating with the insurance provider to automatically update the set of policy guidelines.

7. The method of claim 1, wherein analyzing comprises:
determining a type of the policy;
determining a type of proposed modification;
accessing risk attribute data corresponding to the consumer;
accessing parameter attribute data corresponding to the proposed modification; and
amending the policy in response to the proposed modification being within a threshold based on the parameter attribute data.

8. A policy management system, comprising:
a data processing system operable to receive a proposed modification to a policy of insurance, the policy between a consumer and an insurance provider;
a policy modification module executable by a processor unit of the data processing system to analyze the proposed modification against a set of policy guidelines corresponding to the insurance provider; and
wherein the policy modification module is operable to, responsive to determining that the proposed modification complies with the set of policy guidelines, automatically amend the policy to include the proposed modification.

9. The system of claim 8, wherein the policy modification module is operable to electronically communicate with a data processing system of the insurance provider to automatically update the set of policy guidelines.

10. The system of claim 8, wherein the policy modification module is operable to electronically notify the insurance provider of the amended policy.

11. The system of claim 8, wherein the policy modification module is operable to compare the proposed modification to parameter attribute data for the policy.

12. The system of claim 8, wherein the policy modification module is operable to:
determine a type of the policy corresponding to the proposed modification; and
analyze risk attribute data corresponding to the type of the policy and the consumer.

13. The system of claim 8, wherein the policy modification module is operable to:
determine whether the proposed modification corresponds to a parameter variable; and
responsive to determining that the proposed modification corresponds to a parameter variable, compare the proposed parameter variable to parameter attribute data for the policy.

14. The system of claim 8, wherein the policy modification module is operable to:
determine a type of the policy;
determine a type of proposed modification;
access risk attribute data corresponding to the consumer;
access parameter attribute data corresponding to the proposed modification; and
amend the policy in response to the proposed modification being within a threshold based on the parameter attribute data.

15. A policy management method, comprising:
storing, by a data processing system, a set of policy guidelines corresponding to an insurance provider;
generating and displaying, by the data processing system, an interface for electronically receiving a proposed modification to a policy for insurance, the policy between a consumer and the insurance provider;
analyzing the proposed modification, by a policy modification module executable by a processor unit of the data processing system, against the set of policy guidelines; and
responsive to determining that the proposed modification complies with the set of policy guidelines, automatically amending the policy to include the proposed modification.

16. The method of claim 15, wherein analyzing comprises comparing the proposed modification to parameter attribute data for the policy.

17. The method of claim 15, wherein analyzing comprises:
determining a type of the policy corresponding to the proposed modification; and
analyzing risk attribute data corresponding to the type of the policy and the consumer.

18. The method of claim 15, wherein analyzing comprises:
determining whether the proposed modification corresponds to a parameter variable; and
responsive to determining that the proposed modification corresponds to a parameter variable, comparing the proposed parameter variable to parameter attribute data for the policy.

19. The method of claim 15, wherein analyzing comprises:
determining a type of the policy;
determining a type of proposed modification;
accessing risk attribute data corresponding to the consumer;
accessing parameter attribute data corresponding to the proposed modification; and
amending the policy in response to the proposed modification being within a threshold based on the parameter attribute data.

20. The method of claim 15, further comprising electronically notifying the insurance provider of the amended policy.
